(19) United States
(12) Patent Application Publication
(10) Pub. No.: US 2007/0043481 A1
(43) Pub. Date: Feb. 22, 2007

(54) New Approach to Enroute Aircraft Management

(75) Inventors: Stephen Lee Metschan, Federal Way, WA (US); Uday Arun Kulkarni, Federal Way, WA (US)

Correspondence Address: TEAMVISION CORPORATION, 33305 1ST WAY SOUTH, SUITE B207, FEDERAL WAY, WA, 98003, US

(73) Assignee: TEAMVISION CORPORATION, Federal Way, WA (US)

(21) Appl. No.: 11/161,666

(22) Filed: Aug. 11, 2005

(51) Int. Cl. G01C 23/00; G06G 7/76

(52) U.S. Cl. 701/3; 701/120

(57) ABSTRACT

There are three major problems associated with the current national airspace:
(1) 1. Enroute Capacity
(2) 2. Air Traffic Surveillance
(3) 3. Enroute Operations Integration with Terminal Airspace Operation The proposed invention is aimed at solving above major problems. We have developed the analytical basis for the proposed solutions, and also the schematic implementation methodologies and algorithms in some cases. This provisional patent application is intended to share information about this technology and also to protect the related intellectual property rights of the company in this regard. The technology solution that is intended to be protected includes the following main elements and associated claims in claims section:
(1) 1. Innovative manipulation of Air Traffic Assignment rules as described in claims section to enhance enroute airspace capacity
(2) 2. Using GPS based precision navigation data for Flight Path tracking and surveillance
(3) 3. Integrating Airport/Terminal Slot Allocation (for takeoff and landing) with the enroute flight path assignment; in a sense making it as a packaged assignment

### EXECUTIVE SUMMARY

The National Airspace System (NAS) is an integral part of the United States mobility, security, commerce, and social interaction. Unfortunately, the Air Traffic Management (ATM) system based on existing operational paradigms is reaching capacity in many sections of the airspace critical for the overall throughput of the entire system. While the United States air travel growth is tracking the gradual increase in population and income, the average passenger capacity per aircraft is seen decreasing. These smaller aircraft sizes have in turn produced a significant increase in the overall numbers of aircraft that must be managed by the ATM system. There are strong indications that this shift towards smaller aircraft is not a temporary anomaly but the beginning of a stronger and longer term trend driven by fundamental market forces. While the FAA is implementing a number of solutions to increase the ATM systems capacity, the projected increase of 45% in the next 10 years may not be sufficient to meet the demand if the average aircraft size continues to decline.

In this study, the beginning stages of a solution that could increase the current ATM systems capacity by an order of magnitude are explored. The most effective way of geometrically increasing the airspace capacity was found through the innovative use of two fundamental constraints of volume navigation, namely: Altitude for Direction (AFD) Rule and Vertical Separation Minimum (VSM) Rule. By manipulating these rules we were able to geometrically increase capacity while simultaneously improving navigational freedom. The reductions in aircraft conflicts are based on “optimal flight path allocation algorithm” itself rather than systems relying on the expensive, technically challenging and uncertain real-time “automated conflict resolution” tools. This innovative algorithm utilizes geometric principles combined with scheduling constraints and aircraft performance characteristics to proactively determine least conflicting trajectory for the flight path before the flight path is assigned to a particular flight. This approach combined with GPS based navigation and other technologies provide a solution that is beneficial to almost all stakeholders of the ATMS.

### Heading

CONTENTS

EXECUTIVE SUMMARY 1

CONTENTS 2

LIST OF FIGURES 3

1. INTRODUCTION 4

2. EMERGING TRENDS IN AIRCRAFT GROWTH RATES 5

3. NATIONAL AIRSPACE SYSTEM OVERVIEW 7

4. A NEW APPROACH TO ENROUTE OPERATIONS MANAGEMENT 13

5. ANALYSIS OF RESULTS AND OUTPUT MAPS 24

6. CONCLUSION AND ANALYSIS SUMMARY 28

7. FUTURE WORK 29

REFERENCES 32

APPENDIX 34

### Heading

### LIST OF FIGURES

FIG. 1—Aircraft Categories, Scheduled Departures, and Enplanements (6/2002) 39

FIG. 2—Itemized Aircraft Category Description, Passenger and Range Table 40

FIG. 3—Fractional Aircraft Ownership $ Per Block Hour Pricing Trends 41

FIG. 4—Price vs. Small Aircraft Demand and Peak Airspace Aircraft in the NAS 42

FIG. 5—Example of an Instrument Flight Rules (IFR) Airways Map 43

FIG. 6—System Balance Diagram 44

FIG. 7—Statistical Characterization of Aircraft and Routes in IFR NAS 45

FIG. 8—Funneling Effect of Navigational Point Routing 46

FIG. 9—Free Flight Potential Intersection Conflicts 47

FIG. 10—Adjustable Airspace Paradigms 48

FIG. 11—Basic Capacity vs. Operational Freedom Feed Back Loop 49

FIG. 12—Current Altitude-for-Direction Rule 50

FIG. 13—Schematic of AFD Rules Options 51

FIG. 14—AFD with Altitude Slots Base on Stage Great Circle Distance 52

FIG. 15—Intersection Data Computation and Capture 53

FIG. 16—Rapid Computation of 20 Million Permutations Utilizing FrameworkCT 54

FIG. 17—Design of the 20+ Million Data Points Intersection Database Table 55

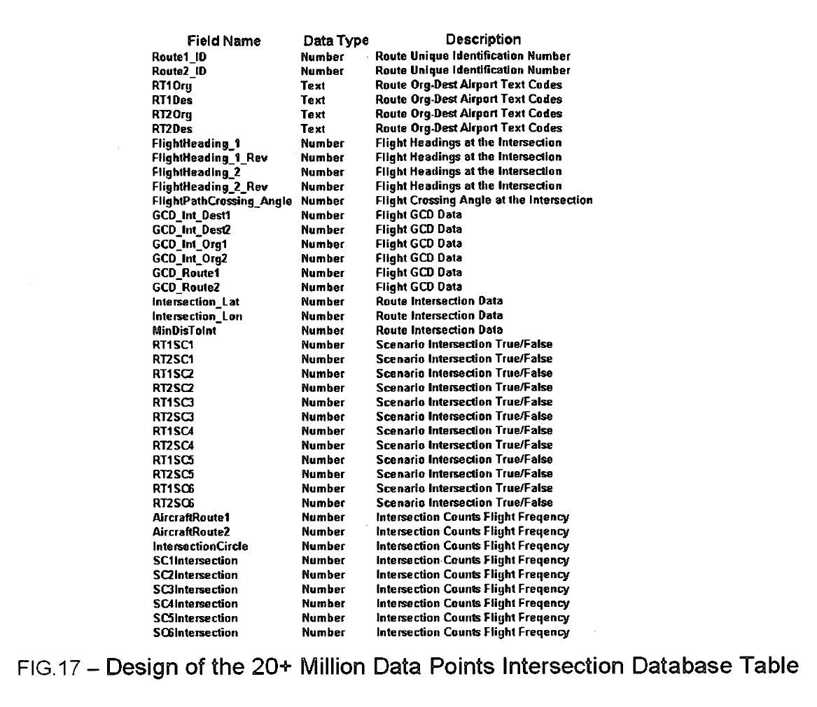

FIG. 18—Flow Chart of Data, Analysis, Results Processing 56

FIG. 19—Current Traffic and Free Flight Scenario Comparison 57

FIG. 20—Various AFD and VSM Scenarios and Visual Comparison 58

FIG. 21—Intersection Traffic Crossing Density 59

FIG. 22—Intersection Conflict Intensity Indicator 60

FIG. 23—Analysis Summary Chart—Rules Comparison 61

FIG. 24—Future NAS Design Concepts 62

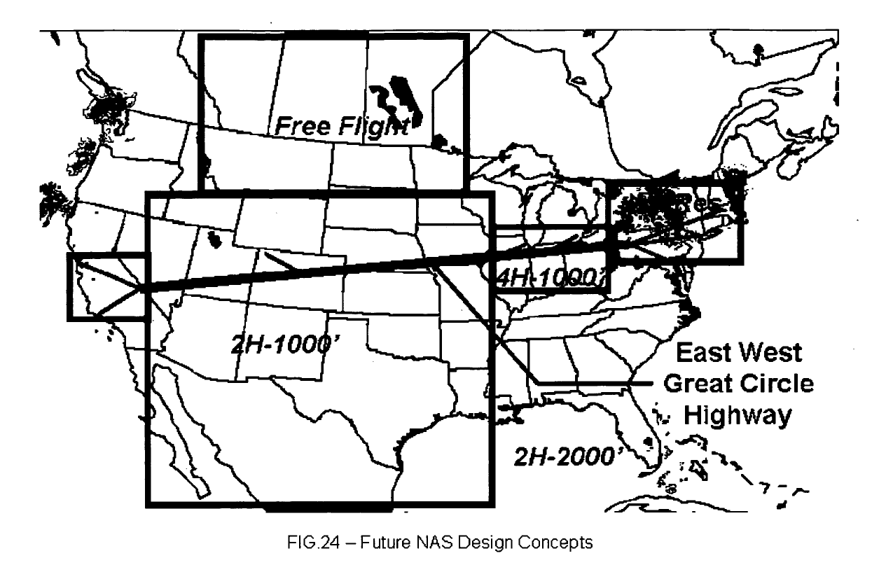

FIG. 25—Geometrical Basis for Spreadsheet Formula 63

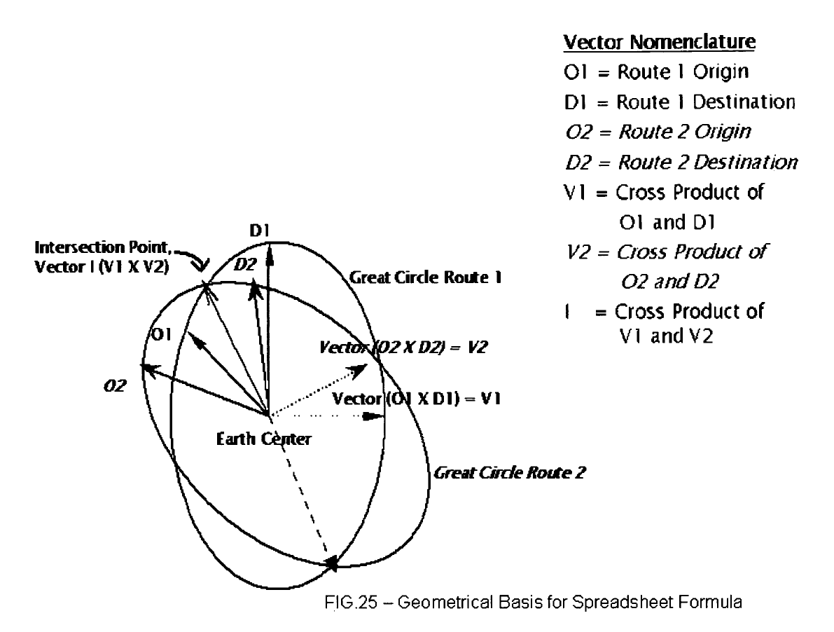

### HEADING

1. Introduction

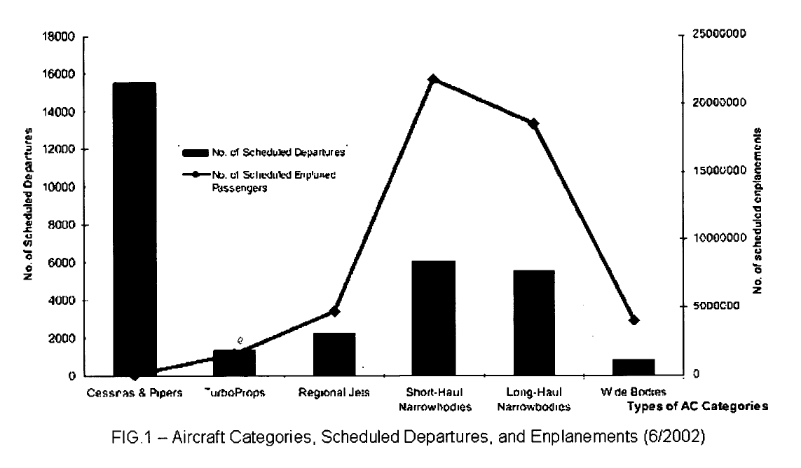

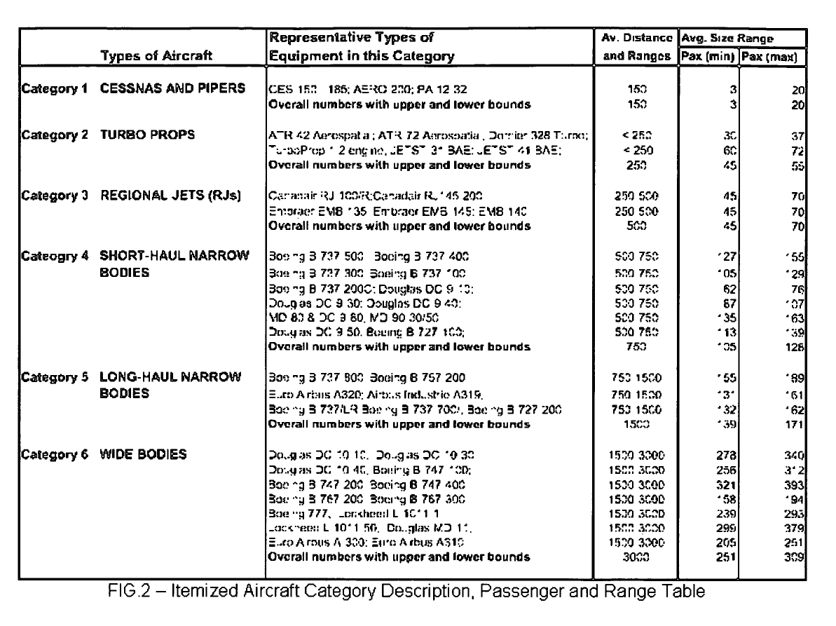

The National Airspace System (NAS) is an integral part of the United States mobility, security, commerce, and social interaction. The efficient use of NAS has become such an integral yet largely transparent part of our everyday social and economic life that many take for granted that it will continue to operate safely and efficiently indefinitely. Unfortunately the Air Traffic Management (ATM) system, based on existing operational paradigms, is near capacity in many enroute sectors critical for the overall throughput of the entire system. Some enroute sectors loads are now routinely at capacity constraints even under ordinary conditions. At times these system constraints have led to the metering/holding of aircraft on the ground during periods of high volume or when dangerous enroute weather requires limiting access along some routes. At present, the enroute ATM handles approximately 5,000 aircraft at peak load and about 1 6,000 total high altitude Instrument Flight Rules (IFR) enroute aircraft in a typical day. The current growth projections of this high altitude air traffic are on the order of 45% by 2015. FIG. 1, shows a breakout of this traffic volume by aircraft type and passenger enplanements in June of 2002. As shown in FIG. 2, the Cessna and Piper categories do not typically interact with the high altitude IFR portion of the enroute airspace due to performance limitations associated with these types of aircraft. In addition, these aircraft categories don't tend to transfer a significant number of scheduled passengers as indicated by the enplanement data. In addition to the increasing demands being placed on the ATM system, the Federal Aviation Administration (FAA) is facing the possibility of an actual reduction in Air Traffic Control (ATC) personnel.

The historic rate of growth in high altitude IFR enroute air traffic has experienced two fundamental shifts in its history. The first shift occurred with the introduction of affordable commercial jet airliners. The second increase was a result of airline deregulation generating increased competition and market innovation resulting in lower prices and new route systems. The United States air travel growth is characteristic of a mature market in which passenger volume increase is closely aligned with net increases in population and income unlike emerging markets like China were growth rates exceed both population and income growth.

### Heading

2. Emerging Trends in Aircraft Growth Rates

While passenger enplanements are growing at a steady and predictable rate, three new trends are starting to cause the increase in air traffic to outpace the enplanement growth rate due in part to a reduction in the average passenger capacity per aircraft. One cause of this larger trend is due to large volume of the United States air transportation market itself. As the volume of passengers continues to increase the number of city pairs that can be economically served with smaller direct flights also increases. Most passengers prefer a direct route over the traditional hub and spoke service provided schedule options and price are at similar levels. This trend will continue to increase the percentage of direct routes at the expense of hub and spoke routes. The development of the hub and spoke system was an essential step in the early evolution of the air transportation system due to the lower historic passenger volumes. The net result of this emerging trend is that as passenger volume increases the average aircraft size will become smaller resulting in a divergence between aircraft traffic and passenger growth rates (3).

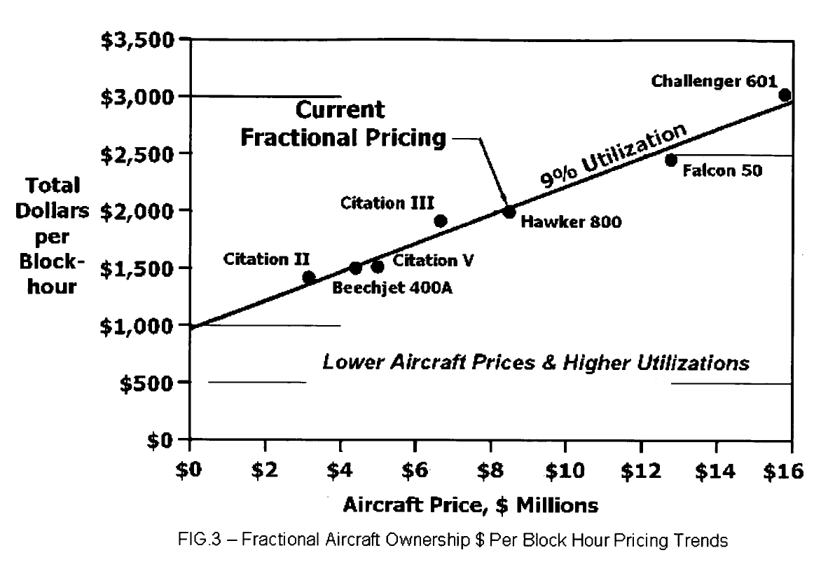

The next emerging trend is the fractional aircraft ownership business model. This legal and business innovation, applied to the currently available aircraft, allows a moderate consumer of air travel to purchase a fractional share of personal use aircraft. This fractional share entitles that shareholder to fly a proportional number of flight hours per year. This innovation has helped lower the pricing structure of short notice business and high income travelers, FIG. 3. While the pricing levels are still very high when compared to a discount fare on a schedule airliner, this new service has made in-roads into small businesses and upper middle class income categories resulting in a further reduction in the average number of passengers per aircraft.

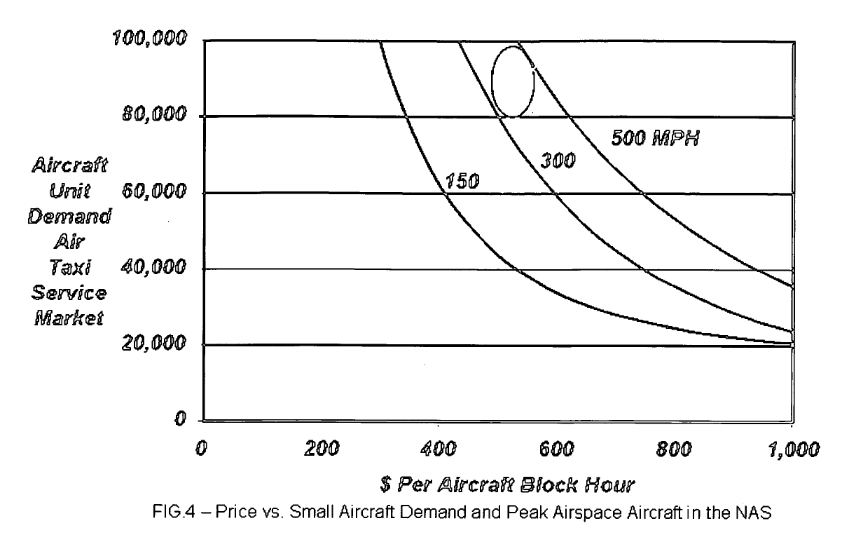

Another trend, still in the very early stages, is the emergence of a low cost On Demand Air Service built upon an emerging new generation of small inexpensive jets operating from the large number of small, quick access sub-urban and rural airports. This new transportation innovation in combination with an Ebay like internet based scheduling system will increase the utilization and load factors of the On Demand Air Service to levels closer to the current Scheduled Air Service system. FIG. 4, shows not only how the non-linear the market demand vs. price is but also what the increase in air traffic could be from just a 10% diversion of passenger demand from the current Schedule Air Service system, resulting in further reductions in the average aircraft size.

### Heading

3. National Airspace System Overview

This section presents the current understanding of the National Airspace infrastructure problems and approaches to solve those.

### Heading

3.1 Current Approaches to Adding Capacity

While reductions in the average aircraft passenger capacity are already taking place, as with any technology, business or market innovation, it will take time for these trends to mature and saturate into their new markets. Along the way other constraints such as airport capacity may be encountered that limit the growth rate or delay the market maturation.

It is always important to have extra capacity in any complex system in order to isolate local disturbances like weather from cascading into a global failure. Over 70% of the current air traffic delays were related to weather problems at the airports and in the enroute airspace (4). As weather moves through a congested portion of the airspace, the displaced traffic needs to be rerouted resulting in bottlenecks on routes that bypass the obstruction as well as higher levels of ground air communication traffic. As typical of other transportation systems, the delay increases are non-linear to the traffic volume when the system is near capacity limits. As the natural volume of air traffic continues to increases these types of ATM system delays will become more common and globally disruptive when they occur. There are two fundamental ways of increasing in airspace capacity.

(Tactical) Increase the efficiency of ATM systems ability to resolve conflicts

(Strategic) Reduce the number of conflicts through airspace redesign

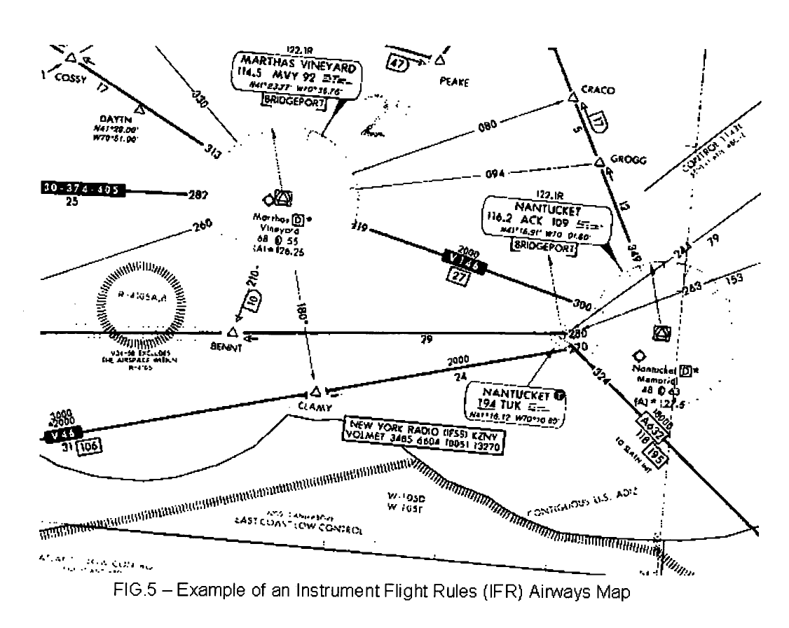

The historic national airspace was built utilizing a series of navigational fixes that form the nodes of an overall network. A typical example of this navigational network is shown in FIG. 5. This system naturally tends to funnel and focus aircraft into intersections that then have to be managed manually by ATC. Potential conflicts are generally resolved through dictated altitude or directional commands by ATC. In certain areas of the airspace, aircraft volumes at these intersections can reach such high levels that they become choke points for the throughput of the entire system. A more natural way to remove the choke points is by dispersing them in the first place through the assignment of great circle based routes, a basic component of “Free Flight” concept. This dispersion of the traffic away from the evolved navigation route constraint points is one natural benefit of “Free Flight” that is being explored. Other approaches to increasing capacity involve the addition of new navigational points, routes and flight levels within routes.

### Heading

3.3 Tactical Approaches to Adding Capacity

The FAA has proposed a number of tactical and strategic improvements in order to increasing the capacity of the ATM system. The current Operational Evolution Plan (OEP) lists various incremental steps phased out in a systematic way (5). Some of the tactical improvements mentioned in this OEP are listed below.

Traffic Management Advisor (TMA)

Overlay Area Navigation (RNAV)

User Request Evaluation Tool (URET)

Enhanced Traffic Management System (ETMS)

Collaborative Decision Making (CDM)

### Heading

3.4 Strategic Approaches to Adding Capacity

While these new systems will allow the ATM system to more efficiently and safely handle increasing level of conflicts, the desire to reduce the overall level of conflicts through more strategic approaches is also being pursued through airspace redesign simultaneously.

### Heading

3.4.1 Reduced Vertical Separation Minimums

While the overall OEP predicts nearly a 45% boost in capacity by 2015 one of the most significant increases in capacity was the result of changing the Reduced Vertical Separation Minimums (RVSM) rule. Currently, the airways are separated by 2,000 feet in the upper most air sector from Flight Level FL290 to FL410. This minimum vertical separation requirement originated from the precision limitations of using barometers for altitude measurement. In the new technology paradigm of precise guidance and control of the aircraft through systems Global Position System (GPS), this separation can safely be reduced to 1,000 feet. This change releases additional airways in the form of FL300, FL320, FL340, etc . . . which can be used alongside the existing flight levels. The European airspace authorities introduced this same change successfully in the year 2002 resulting in a significant reduction in enroute congestion and traffic delays. This rule change alone accounts for almost half of the 45% projected increase in enroute capacity in the OEP.(6).

### Heading

3.4.2 Free Flight

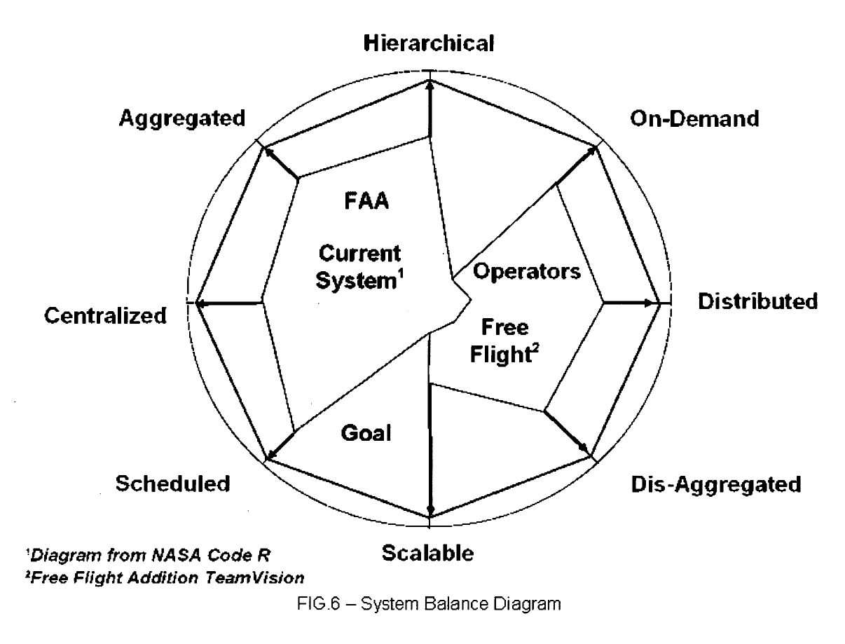

In 1997, Radio Technical Commission for Aeronautics RTCA Inc., a non-profit organization whose main function is to build consensus amongst all the aviation system's stakeholders and work with FAA in an advisory capacity, presented its Free FlightAction Plan to FM. The FAA responded quickly to RTCA Inc.'s presentation and incorporated the findings in an Action Plan called “ATS Concept of Operations in 2005” along with the revised version of National Air Space Architecture (1), FIG. 6. Further down the road, FAA broke down the implementation in two phases called: Free Flight Phase 1 (FFP1) and Free Flight Phase 2 (FFP 2) (2) of the above Action Plan.

These plans FFP1 and FFP2 in action have some obvious benefits. For example:

Transition to Satellite/GPS Based Navigation

Automatic (Computerized) Conflict Detection, Decision Support and Resolution

Updated and Certified New High Performance Avionics

The Federal Aviation Administration's 1998 Free Flight initiative is being implemented in two phases with the first phase near completion. The basic concept of Free Flight is to enable aircraft operators to freely choose the most desirable flight path. A major concern with pure Free Flight is that if everyone is allowed to choose any altitude and direction they want, a geometric increase in enroute conflicts could result. Russell A. Paielli and Heinz Erzberger of NASA Ames provide some basic ways of estimating such conflicts (15) and David Dugali makes an effort to resolve such conflicts using flow separation phenomenon under scheduling constraint (7). Based on similar studies researchers at MITRE have developed what is called as “User Request Evaluation Tool (URET)” (16). This software is currently installed on six of the Route ATC locations and it is expected to be installed in the remaining 14 locations by the end of the FFP2. MITRE also published the “free flight conflict probe operational description” which deals with operational issues of free flight and URET (17). The process in short works as follows: A Free Flight plan is generated by the pilot and submitted in the “collaborative decision making” (CDM) software tool. The conflict is identified by URET between two approaching aircrafts and it is taken care of by “lateral amendment” i.e. by changing direction of the aircraft but keeping the same altitude (18). All these initiatives are an attempt to automate the enroute operations through computer assistance, which will certainly help in reducing the work load of the ATC and thereby improve overall smoothness in the system. The capacity consequence of these initiatives is not found to be quantified in the present literature. Tools like the Intersection Density Analysis Toolset (IDAT) developed by CAASD form a useful background in understanding the new ATM operational paradigm we will discuss in the next section.

### Heading

4. A New Approach to Enroute Operations Management

This section explains the innovation and the new approach to device next generation ATM System with multifold airspace capacity

### Heading

4.1 Overall Goal and Approach Development

The goal of this innovation can be stated in a very simple way: “To develop an Air Traffic Management solution that increases the current capacity by an order of magnitude utilizing today's technologies while improving the satisfaction of its all stakeholders.”

This approach is aimed to be holistic and innovative where conflict resolution is treated as a “proactive element” of flight assignment rather than a real-time mid-air resolution. Due to the proactive approach, the flight path assigned is more conflict free. The real innovation is in reestablishing the “altitude-for-direction” rule of navigation such that it generates more conflict free flight paths.

Thinking of holistic strategies to reducing the frequency and density of aircraft conflicts leads one to geometric fundamentals of intersecting lines. The result of which suggests that the most effective way of geometrically increasing NAS enroute capacity lies in an innovative use of two fundamental constraints of volume navigation, namely: Altitude for Direction (AFD) Rule and Vertical Separation Minimum (VSM) Rule. The ability of manipulating these rules to geometrically reduce conflicts in congested areas of the airspace while increasing freedom in lightly traveled regions is based on the fundamentals of geometry itself rather than focusing on the tactical efficiency of managing the conflicts as they arise.

### Heading

4.2 Current Enroute NAS Aircraft Data Collection Characterization

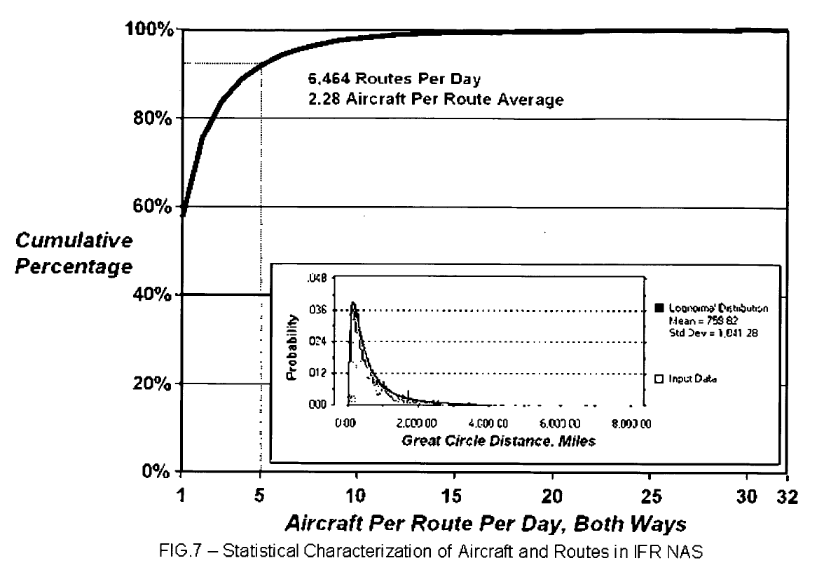

The first step was to find an actual aircraft flight schedule for a typical day in the United States NAS. While there are any number of datasets that one could use our main purpose was to explore the particular algorithms and conflict magnitudes associated with this new approach to enroute conflict management. Also, due to the fact that we were mainly interested in exploring great circle routing scenarios, the amount of information contained in a typical ETMS dataset was more extensive than we currently needed to explore the basic concept of direct routing. We obtained an actual aircraft origin and destination schedule from a program called AirNav developed by Air Nav Systems. The software retailer's web site can be found by going to www.airnavsystems.com. There were almost 15,000 flights contained in the data set, the statistics of which are shown in FIG. 7. Along the x-axis is plotted the volume of aircraft per day that transit a particular route in both directions while the y-axis accumulates the number of routes with that particular traffic volume. While there was one route that experienced a frequency of 32 aircraft going in one direction per day the average for all 6,464 routes was only 2.28. In fact, over 90% of the routes experience less than five aircraft per day. The mean great circle distance was also interestingly only 758 miles. As shown previously in FIG. 1, the approximate number of 16,000 aircraft departures in the CAASD June 2002 chart is very close to the AirNav dataset once the low altitude category one aircraft were removed.

### Heading

4.3 Rules of Direction and Altitude

It is almost always desirable to fly on the great circle route that connects the origin with the destination. While there might be some variations on the best trajectory due to prevailing wind patterns, the Great Circle Distance (GCD) is usually the most efficient. Based on the direction or “heading”, which is measured as the absolute angle the direction makes with the north in the clockwise direction, the aircraft is assigned an altitude. If the heading is between 0 and 179 degrees, eastward flight, the aircraft gets a different altitude to fly than if the heading is between 180 to 359 degrees, westward flight. This rule originally evolved to eliminate the potential of a collision between two aircraft traveling in the opposite direction on the same route defined by the same navigational aids. This rule also helped to reduce the closure speed between two aircraft as they approach a common intersection. In addition, the United States air route system has a high degree of directional bias in the East-West or West-East direction which can naturally take advantage of a north/south split.

### Heading

4.4 The Strategic Solution Outlook

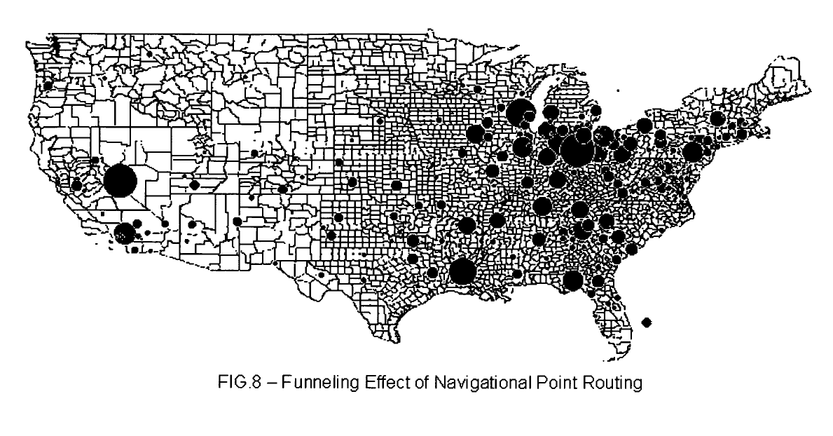

The fundamental capacity constriction of the existing NAS system is a vestige of the original navigation route system. Prior to Global Position Systems (GPS), aircraft navigation was accomplished through the construction of a series of radio beacons. These radio beacons formed the nodes of large network that connected airports all across the country to each other. These navigation points in the route network, while perfectly adequate for the air traffic volumes of the past, are become serious constraints to NAS capacity required today. FIG. 8 shows the distribution of the number of aircraft path intersections or conflicts handled by particular navigational points in the US Airspace. The area of the circle is representative of the probability of conflict at that navigation point. This map was generated by crossing the AirNav Systems database with the FAA preferred routes database. The FAA preferred route database contains a sequence of navigational points between most airports. What this analysis effectively did was it found the navigational points that will experience the greatest number of conflicts per day based on a preferred routing of a typical day's volume of aircraft.

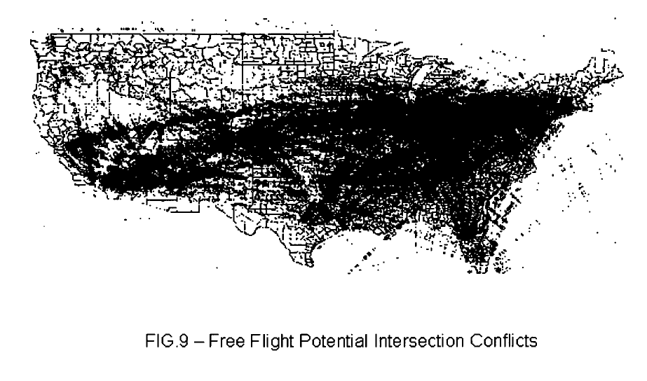

In stark contrast to the current radio “funneled navigation” route/intersection airspace design is the “Free Flight” concept, shown in FIG. 9. While free flight will reduce the funneling effect inherent in the current system, it simultaneously generates a geometric increase in the number of potential intersections. In this figure one can see what more than 500,000 flight path intersections looks like. Even though each intersection has a low probability of producing an actual conflict based on time and schedule, this new approach would quickly swamp the existing command in control approach of ATC.

It might be possible to blend together the two paradigms of navigational routes and free flight into one NAS concept that draws upon the benefits of both worlds while increasing capacity and freedom at the same time. Another interesting observation is that the United States Airspace is not uniformly congested. This would suggest that the best balance between these two approaches may change as function of location and time.

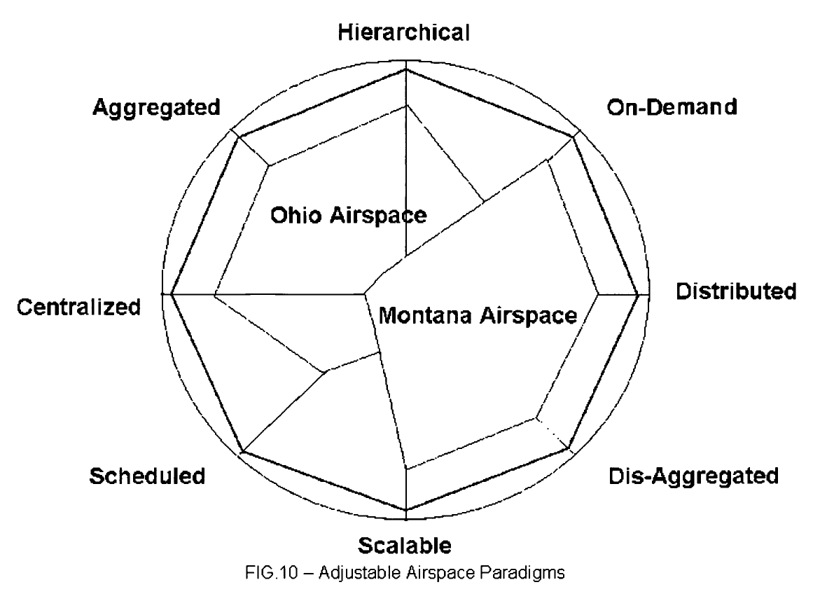

There are two fundamental rules that govern the entire air space: Altitude-for-Direction and Vertical Separation Minimums. This fixed rule set is applied uniformly to an airspace that experiences significant fluctuations in traffic loads and weather conditions continuously. For example, the airspace near Cincinnati is very congested and free flight in that region could be a huge problem and hazard even for future technologies and processes. At the same time, airspace over areas like Montana many not present a problem for Free Flight even with today's technologies. Governing every part of airspace with a same rule of navigation is inherently less inefficient. An alternative notional approach is shown in FIG. 10. The best balance of capacity vs. flexibility might be better addressed by adjusting the rules to best suit the overall conditions of a particular airspace sector. Even the sector definitions themselves might be up for a more dynamic adjustment as well. Allowing these types of changes to be done dynamically might allow for a system that can adjust and adapt to short, intermediate, and long range changes more effectively.

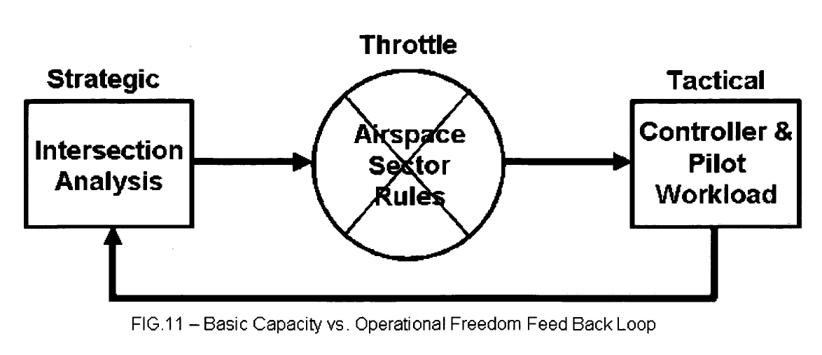

In this systematic analytical process, one can still manage to give a better choice to the customer (the airliners) for the altitudes in the places where it is possible. These “Optimal Air Traffic Rules” can be designed and tuned to specific needs of the involved parties based on time and space. A basic schematic of this approach is shown in FIG. 11 in which the Airspace Sector Rules are used to throttle the conflict workload experienced by the ATC. In this way more restrictive rules could be used during periods and in airspace sectors of high congestion and then relaxed later for a more free flight like operating environment.

### Heading

4.5 The Alternative Flexible AFD Rules

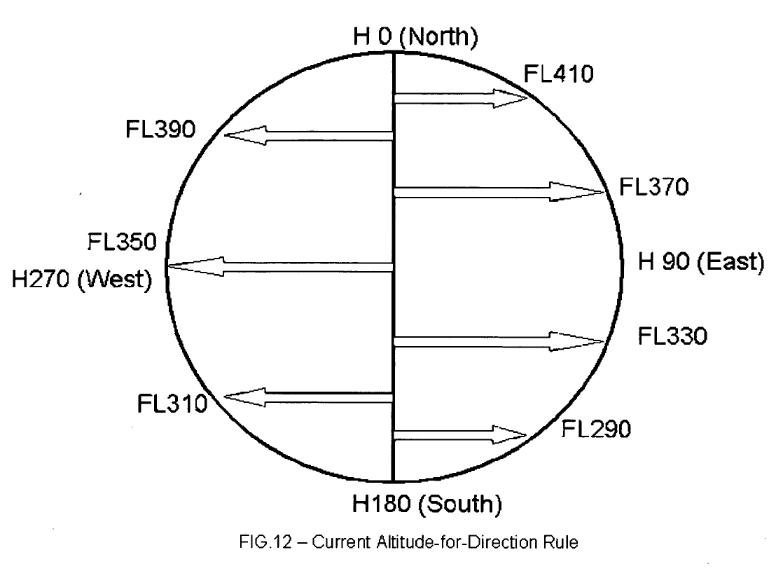

There are two degrees of freedom for a flight: the Direction and the Altitude. This rule can be illustrated graphically from the following FIG. 12. In a hypothetical case if someone is flying right towards East, i.e. heading 0 to 179, he or she is assigned any of the four available altitude decks. Similarly, if someone is flying West, i.e. heading 180 to 359, he or she is assigned remaining three altitude decks. Based on this eastward or westward air traffic division and assigning different flight levels to them, the system minimizes the chances of head on conflicts. But, all the eastward traffic and all the westward traffic share common altitudes and thereby have potential conflicts. These conflicts are generally resolved by manual redirections in the altitude or lateral amendments to the flight paths of one or many aircraft.

The problem of conflicts within Eastward or Westward traffic can be further minimized if each of those directions can be further divided in two or more sections and assigning different altitude levels to those sections. This strategy of dividing traffic in separate altitude levels can be synchronously applied with Reduced Vertical Separation of the Flight Levels to 1,000 feet or 500 feet. This manipulation creates several combinations of the AFD and VSM rules that can be applied to airspace regions where it makes sense to apply them based on congestion of a particular region of the airspace. In a congested area of the airspace it makes sense to apply more predetermined direction based altitude and the less congested airspace regions could be treated as a near free flight environment. This insightfulness of applying these rules not as a constraint but for an advantage of preemptive conflict resolution is being stated as one of the claims as an innovation and being applied to be a patent.

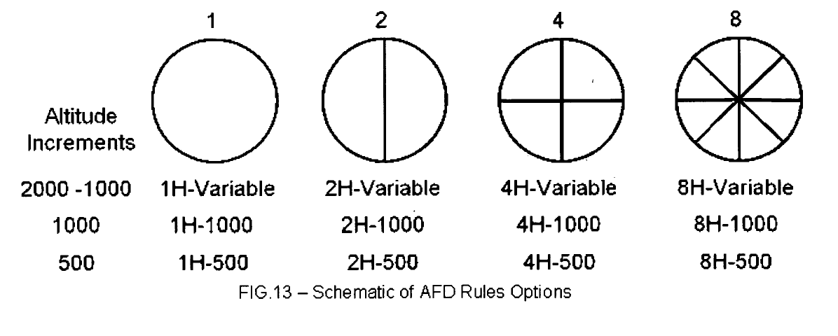

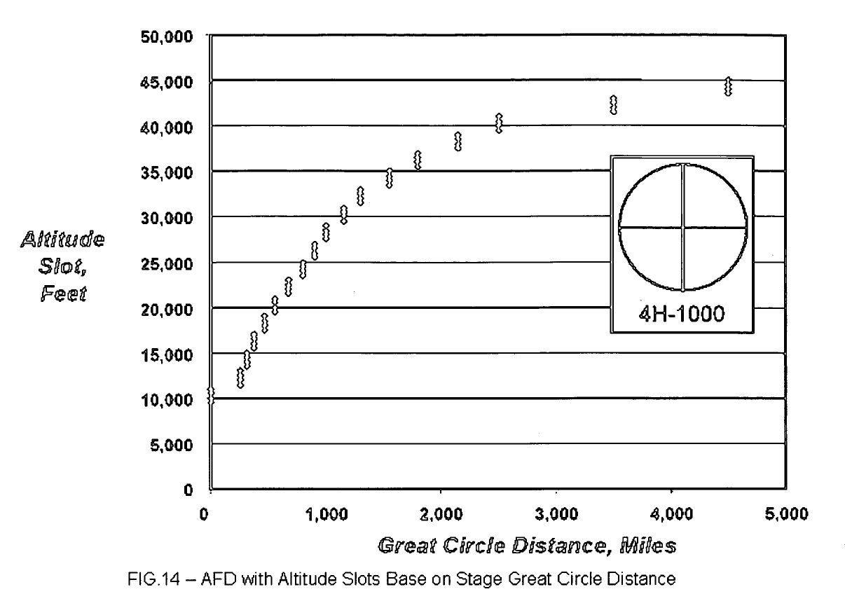

FIG. 13 shows a schematic of the various AFD rules as applied to headings and altitude separation levels. A second concept is to assign these altitude segments based on the Great Circle distance of a particular route. As shown in FIG. 14, the longer the stage length, the higher the altitude assignment. This rule serves a number of purposes. First the altitude slotting will tend to place a priority of assigning higher optimal flight altitudes to the longer distance routes. In addition, assigning short distance routes to the lower altitudes prevented the relatively frequent flights for interacting with the long distance routes reducing conflicts significantly. This overall approach tended to spread aircraft throughout the airspace minimizing conflicts in heavily congested areas. There is a significant potential in this concept for further refinement, some of which will be discussed in the Future Work section.

### Heading

4.6 The Mathematical Model

The main purpose of the model was to quantify the impact of the conceptual ideas of changing rules stated above on the actual air traffic patterns and the number of potential geometric conflicts. The very intent of these new ideas is to strategically minimize/adjust the aircraft route conflicts using geometric solutions by choosing a right “altitude-for-direction rule” design that matches the capacity requirements with ATC workload. The model thereby contains various pieces and three of the most important pieces are listed below:
Route Database (List of routes, Origin, Destination, and their Lat-Lon's, Flight Frequency on each of the routes, etc.)
Intersection/Conflict Spreadsheet (The Spreadsheet for identifying if the routes conflict and the respective data computations)
Intersection Database (Route Intersection points details, GCD's, Flight Headings)

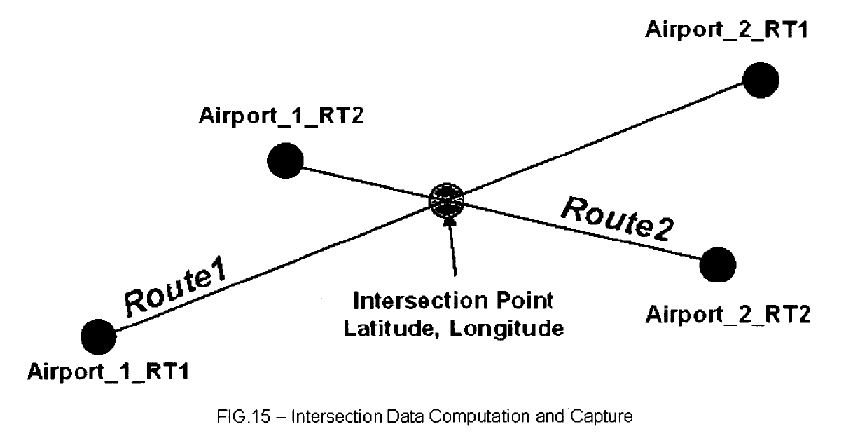

FIG. 15 shows two possible routes intersecting in airspace amongst many that are used on the daily basis. The US airspace, at high enroute altitudes, is used by roughly 15,000 aircraft on a daily basis. These 15,000 aircraft utilize about 6,500 individual point to point routes. Each route needs to be checked with every other route for a possible intersection. This makes it 6,500 times 6,500 divide by two which produces 20+ Million potential intersections.

The following is a general outline of the Intersection spreadsheet model logic. More details are available in the Appendix of this document. Given the coordinates (latitudes and longitudes) of the Origin and Destination of each route, one can find out mathematically if the routes will intersect and where that intersection point is located. At this intersection point of the two routes there are four possible flight paths, each having its own heading angle. In addition, each route has Great Circle Distances of both routes and distances of respective origin and destination points to the intersection point. Thus, the Intersection spreadsheet model processed all 20+ Million route combinations in order to generate the route intersection matrix.

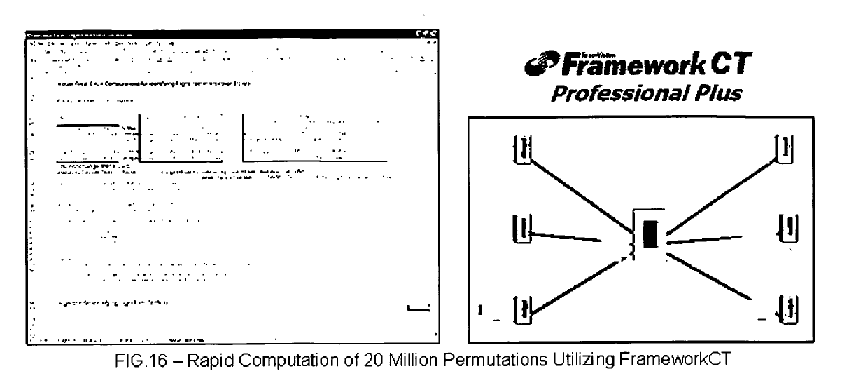

This rather large number of potential route intersections can be quickly processed utilizing the massive parallel processing facility of FrameworkCT Professional Plus, FIG. 16. After calculating these 20+ million potential route conflicts, data is stored in software's data file which then is exported to Microsoft Access Database for post-processing. In this post-processing, it was found that out of 20+ million potential route intersections, there are some 1.1 million actual geometrical intersections of the routes. Many of them (about 412,000) occur within 50 miles of the origin or destination airport of either route. Typically, when an aircraft is within 50 miles of the airport it is well below the enroute airspace and sometimes even within the controlled airspace of large airports. For example, a great circle routed flight originating from London and destined for Atlanta would cross Boston, New York and Washington DC at high altitudes. While this might create a theoretical geometric intersection with the traffic on approach or departure from these East Coast airports, they would all be at a much lower altitude than the London to Atlanta flight. Once these remaining geometry intersections (about 688,000) are then checked against the actual active routes in a typical day's flight schedule, the number of potential intersections that the ATC needs to potentially resolve further reduces to 139,000. It is important to note that managing even this number of intersections is still large and could overwhelm the current ATM system.

### Heading

4.7 Data and Analysis Processing Flow Diagram

The column layout of the intersection analysis output results is shown in FIG. 1 7. Each row or “record” in this matrix can be thought of as a permanent computed Route Conflict/Intersection point that can be searched quickly. For example, one can lookup quickly all the routes that intersect the Chicago (ORD) to Los Angeles (LAX) route and at what points. This lookup database of all possible intersections is an important foundation for futuristic Automated Computer Routing. In this analytical study, this database serves as a major source of our statistical findings related to various scenarios used in redesigning airspace rules as discussed further in the Future Work section.

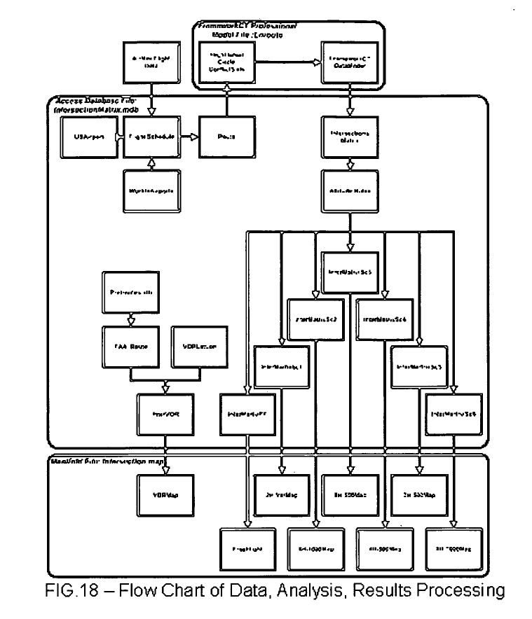

A chart describing the data, analysis, results process and mapping flow is shown in FIG. 18. Once the Intersection Matrix was built we need to process the multitude of records both statistically and graphically. In order to graphically process the information we used a software product called Manifold. Manifold is Geographic Information System (GIS) software product which can be purchased at www.manifold.net.

### Heading

5. Analysis of Results and Output Maps

A total of eight airspace rule scenarios where examined statistically and plotted in a separate GIS map. Each map shows the locations of the route intersection points that remain after the new airspace rules have been applied as well as the probability of conflict as indicated by the circle area. The probability of the conflict is directly proportional to the multiplication of the “air traffic frequency” on each route. Various scenarios are described with respective output graphs.

### Heading

5.1 Current Airspace as Opposed to Free Flight

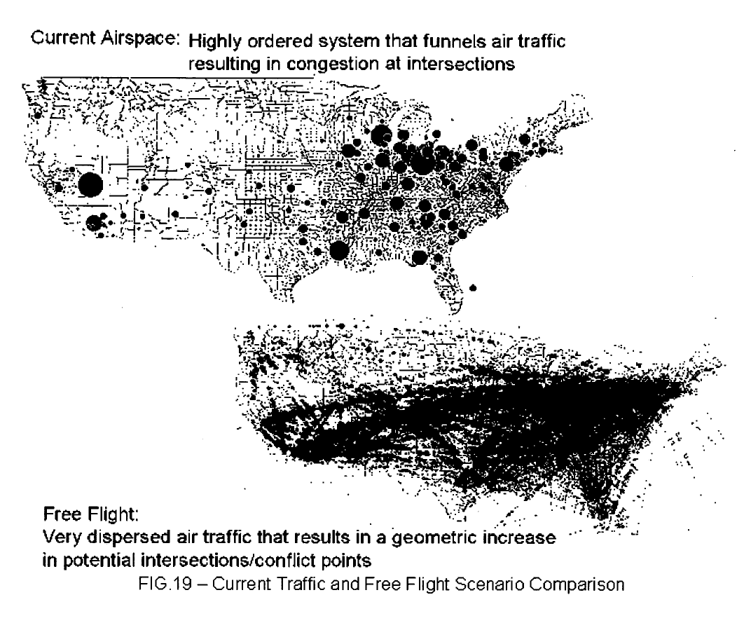

FIG. 19 shows the direct comparison of the two extreme situations. The first one, the current traffic rules, force the Northeast section traffic flying towards the Southwest part of the country to fly through the handful of preferred navigation points resulting in traffic funneling and overload. The extreme opposite case is seen in the free flight concept which natural spreads out those same flights, results in a geometric increase in the number of potential intersections. While the conflict probability of these free flight intersections is low the shear number would result in an overload of the existing ATC system. Even future automation may be unable to cope with the intersection density in some sectors due to the principles of chaos theory.

### Heading

5.2 Effect of Changing AFD Rules

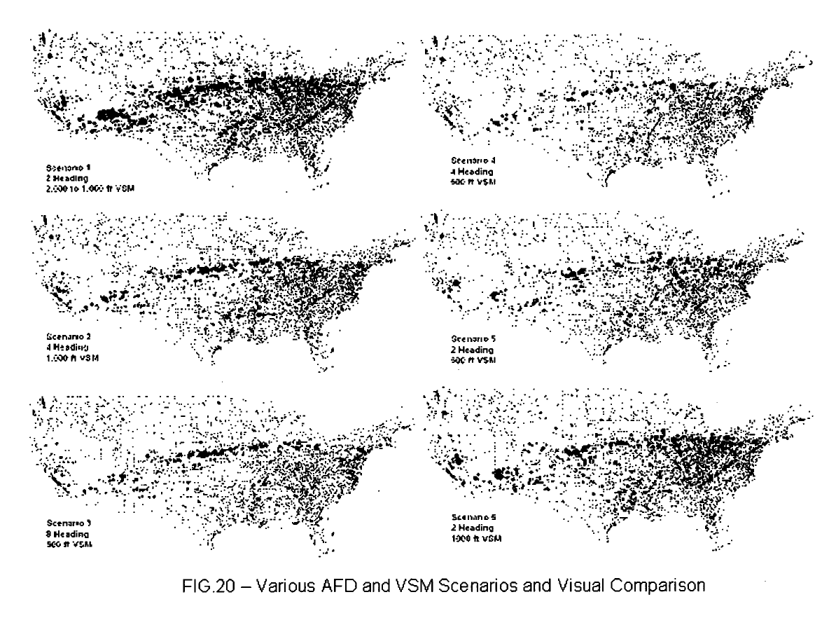

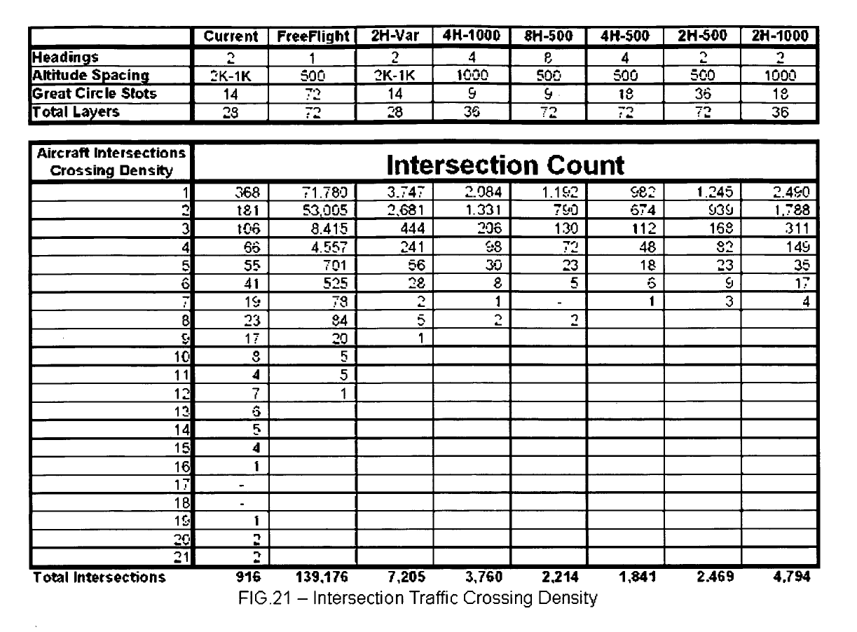

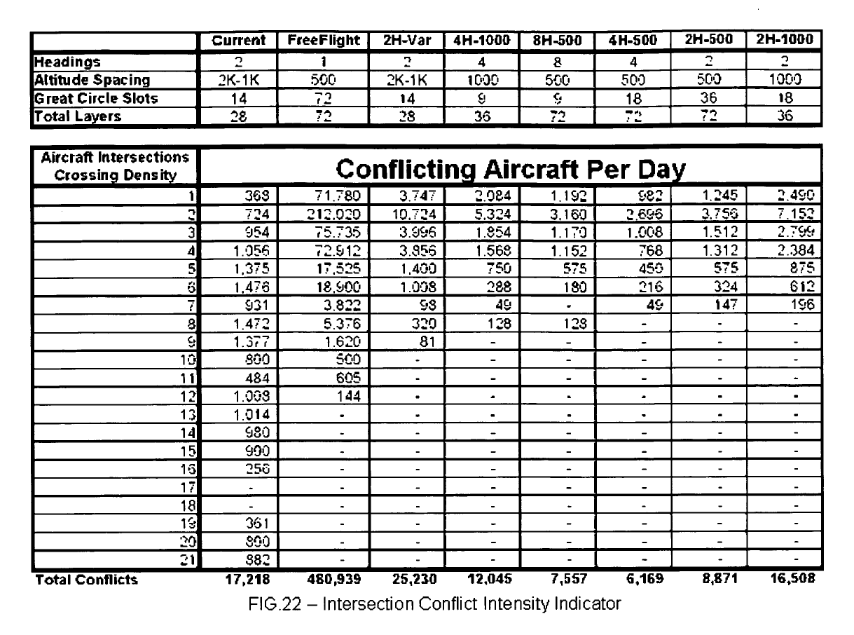

As noted previously, there are various possibilities of providing Altitude (Flight Level) based on Flight Distance and Flight Heading. There are four possible AFD rules and with each AFD there are three levels of Vertical Separation Minimums (VSM) as shown in FIG. 13. This makes twelve possible scenarios with the combination of these AFD and VSM rule sets. Out of these possible scenarios six were chosen for study and are mapped in FIG. 20 and statistically shown in FIGS. 21 and 22. The comparison of various scenarios has two aspects: The number of intersections and probability of conflict. The degree of conflict probability is shown by the “area of the plotted circle” in the graph and can be cross compared with all previous and future figures that deal with this type of data.

### Heading

5.2.1 Scenario Analysis

Scenario 1: This scenario required the least change in the current rules of the NAS. It keeps both AFD and VSM identical to today's rules except that in this scenario the flight path is a “GCD” path and not the radio navigation. This helps in dispersing the traffic in the airspace there by reducing the general conflicts. From the statistics one can see that GPS based GCD routing disperses the air traffic and increases the number of Intersection points but the severity of conflict at each intersection is reduced significantly compared to the Current Airspace. Particularly, “highly congested” sections of air traffic handling more than ten planes on each crossing routes are reduced to “none” with the GCD routing which are in high numbers in the current airspace.

Scenario 2: This is probably the best combination of AFD and VSM based on convenience, simplicity and benefits in reducing conflicts. In this rule set, the airways are separated by 1,000 feet altitude increments for whole airspace. The whole airspace is then divided in number of slots based on the number of groups of similar GCD flights. Each slot is then further divided in four particular flying altitudes and actual assignment of Flying Altitude is based on quadrant based AFD. One can see immediately from the graphs that Scenario 2 reduces the conflict probabilities further. The total conflict probability indicator, which is the sum of conflict probability at each intersection times the number of intersections, shows that the over all conflict severity is reduced by half in Scenario 2 compared with the Scenario 1.

Scenario 3: This scenario increases the segmentation of the airspace both in altitude terms by reducing the VSM to 500 feet and has eight sections for the AFD rule resulting in all planes traveling in the same 45 degree heading segment to potential have conflicts. Because of this higher segmentation, the number of intersections drops still further compared with previous Scenario 2 which has only one fourth of number of traffic segments. But at the same time, as some of the additional segments are not utilized efficiently, the impact on reduced conflict probability is not that impressive. This particular fact makes a salient point that more segmentation is not always an effective way of reduce the conflicts.

Scenario 4: In this scenario the altitude separation is maintained at 500 feet but the number of direction segments is reduced to four. Interestingly, as the direction based segments are reduced in exchange with distance segments keeping total segments same at 72, this set of rules gives the least probability of traffic conflict. The total Conflict Probability Indicator is almost 1/3 in comparison with the current air traffic and at the same time the maximum load at any intersection is also reduced to less than ⅓ (seven planes each way in this Scenario in comparison to 21 max on each way in the Current Airspace). This theoretically suggests that it is possible to triple the capacity by playing with these rules effectively.

Scenario 5: This scenario uses the current heading rules but with reduced vertical separation to 500 feet. As explained in the previous scenario description, this set of rules also helps in traffic segmentation based on flight GCD and reduces conflicts, but this scenario is less effective than the previous scenario. This is a strong indication that changes in the AFD is sometimes more effective at reducing intersections than VSM.

Scenario 6: This is the most likely near term scenario from an actual implementation standpoint. In comparison with the current approach, it has two additional elements of distinction: GCD based routing and 1,000 feet separation. This scenario however does not change the number of segments based on direction as the current AFD rules are maintained the same. That number of segments remains same at two, meaning East—West direction based even odd altitude flight levels rather than four segments (or quadrant rule) as in Scenario 2. In effect, the total conflict probability of this scenario remains nearly the same with some marginal improvement vs. the current air traffic but because the intersections are dispersed by GCD routing the number of intersections having near max capacity traffic are drastically reduced. This is a significant gain for ATC and adds flexibility in comparison with current traffic. But Scenario 2 fairs better than Scenario 6 because it reduces the total probability of conflict by the factor of ⅓ compared with current air traffic rules.

### Heading

6. Conclusion and Analysis Summary

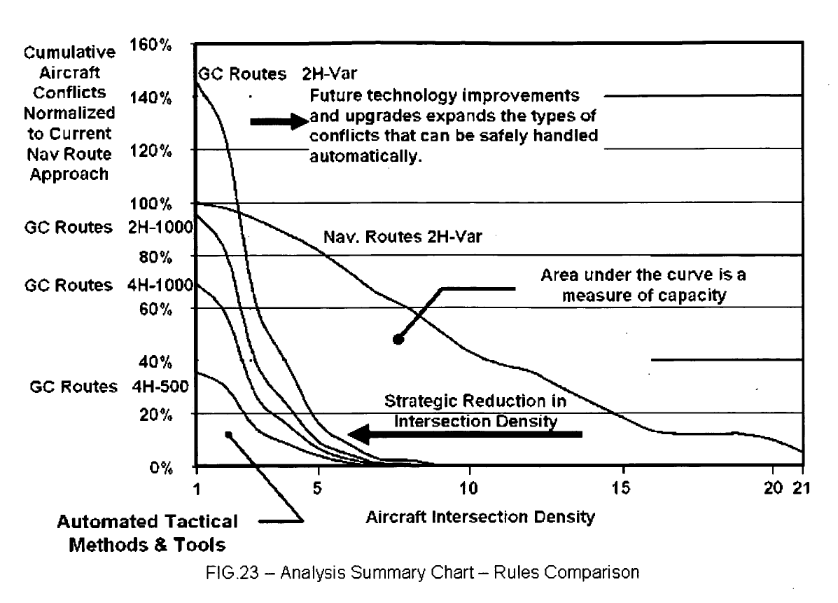

FIG. 23 shows graphically a summary of the statistical analysis shown in FIG. 22. It can be seen from the analysis data generated, that the GCD routing helps in dispersing the air traffic thereby reducing the “intensity (probability) of conflict” at the intersection. But in the process of dispersing the traffic, the number of intersections will increase geometrically. Using the degrees of freedom of AFD and VSM rules the intersections can be significantly reduced and even brought back to levels similar to the current system while still maintaining GCD routing. What is truly exciting about this approach is that most of the procedures and protocols associated with the current navigational route system are still used. The main difference is that the intersections that are now being managed are ones that exist naturally and are not a vestige of how the system historically evolved. Another important finding is that this approach could be instrumental in lowering the overall conflict density to levels that the first generation tactical conflict management tools can safely and reliable handle.

Based on this presented analysis, four Segment AFD and 1,000 feet separation gives near term best combination for boosting the NAS enroute capacity by up to about five times over the current one. This level of increase should be sufficient to remove the enroute capacity as a NAS bottleneck issue and move the constraint to other areas like airport capacity.

### Heading

7. Exporation of Further Concepts Based on This Methodology

The work presented here is just a first step of many in a complete system development towards a truly new approach to enroute operations management. There are some important future enhancements that would be useful in exploring this methodology further and allow the analysis to better approximate the working conditions and constraints of an actual operational system.

### Heading

7.1 Model Analysis Tactical Improvements

The current model does not include the effects of restricted airspaces or severe weather. The ability of a system to adjust to these constrictions in the airspace quickly, safely and without bottlenecks is very important. Additional improvements could be made by incorporating the concept of active and in-active routes allowing the system to facilitate a greater level of freedom when it comes to managing assignments based on actual flight schedules.

(1) 1. Including Restricted Air Spaces

(2) 2. Including Moving Restricted Air Spaces

(3) 3. Including Schedule Effects

### Heading

7.2 Airspace Utilization Optimization

As mentioned before the airspace is highly heterogeneous in terms of the air traffic load. This suggests that efficiencies of the NAS could be improved significantly just be varying the operating rules by sectors and load. In some places airspace sectors, like Montana where the traffic is sparse, Free Flight and minimum restriction is a practical operational environment. On the other hand, highly crowded airspace sectors between Cleveland and Cincinnati might need to have more constrictive and highly organized structure in order to reduce ATC workload and maximize throughput. Also, time of day may introduce significant changes as well in the optimally air traffic management rules. These kinds of rule optimization studies based on time and space coordinates are being conceived at this point and the specifics of which would be included in the future patents.

### Heading

7.3 Other Advance Concepts

There are some other advance concepts that are being explored in connection with this patent application. For example, based on the map presented in FIG. 9, it can be seen that there is some definite air traffic patterns that resemble something like an “air highway”. The major routes from east coast to west coast between cities like Boston/New York and Los Angeles/San Francisco form one such highway, which incidentally overlays some other big cities in the mid-west like Cleveland, Detroit, Chicago. This natural alignment forms the heaviest air traffic channel that can be considered as a “major air highway”. This traffic needs to be highly coordinated and scheduled in the current system. In this context, it is worth exploring the concept of devising this high volume same directional traffic as a “six lane highway”. By providing additional lanes that are separated by certain safe distance, this air space can be dealt with easily. Similar secondary traffic patterns exist between other high density air routes and they can be developed as “secondary highways” with under and over passes at certain points to further minimize the conflicts while maximizing the freedom everywhere else. The incorporation of aircraft performance into route and altitude assignments would allow the model to strategically and tactically adjust and optimize the entire transportation system for various traffic and weather environments continuously.

### Heading

### REFERENCES

(1) Federal Aviation Administration; “ATS Concept of Operations for the National Airspace System in 2005”, September 1997.

(2) Federal Aviation Administration; Free Flight Phase 1 (FFP1) and Free Flight Phase 2 (FFP2), website: http://ffp1.faa.gov

(3) R. John Hansman, MIT International Center for Air Transportation; “The Dynamics of the Emerging Capacity Crises in the US Air Traffic Control System”, 2001.

(4) Martin Dresner, Robert Windle, Yuliang Yao; The Economic Impact of Airport Congestion—A Workshop on Airline and National Strategies for Dealing with Airport and Airspace Congestions, University of Maryland, March—2001.

(5) Federal Aviation Administration; National Airspace System Operational Evolution Plan—“A Foundation for Capacity Enhancement 2003—2013”, December—2002.

(6) Eurocontrol—The European Air Traffic & Safety Management body; “2002 the Year that Revolutionized the European Airspace Architecture”, Skyway—Spring 2003, http://www.eurocontrol.int/library/skyway/2003/spring/p41.pdf

(7) David Dugail, “En-route airspace capacity under flow separation and scheduling constraints”, Master of Science Thesis, Department of Aeronautics and Astronautics, MIT, June 2002.

(8) Alexander Bayen, Pascal Grieder, and Claire Tomlin; “A Control Theoretic Predictive Model For Sector-Based Air Traffic Flow”, NASA Ames Research Center and Stanford University, AIAA Guidance, Navigation and Control Conference, August—2002.

(9) Amedeo R. Odoni, Jeremy Bowman, et. al.; Existing and Required Modeling Capabilities for Evaluating ATM Systems and Concepts, International Center for Air Transportation, MIT, March—1997.

(10) Massoud Bazargan, Kenneth Fleming, Prakash Subramanian; A Simulation Study to Investigate Runway Capacity Using TAAM, Proceedings of the 2002 Winter Simulation Conference, 2002.

(11) Karl Bilimoria, Banvar Shridhar, Geno Chatterji, Kapil Sheth, Shon Grabbe; FACET—Future ATM Concepts Evaluation Tool, 3^{rd} US/Europe Air Traffic Management R&D Seminar, June—2000.

(12) George H. Solomos; Analysis of Excess Flying Time in the National Airspace, Center for Advanced Aviation Systems Development (CAASD), MITRE, March—2003.

(13) Douglas Baart, FAA Tech Center; An Evaluation of Future Routing Initiatives Case Study—Southern Region.

(14) Dan Citrenbaum, Operation research and Analysis Branch, FAA; The Challenges of Modeling Future En Route Enhancements, March—2003.

(15) Russell A. Paielli and Heinz Erzberger; Conflict Probability Estimation for Free Flight, NASA Ames Research Center, Moffett, Calif., 1997.

(16) Federal Aviation Administration; User Request Evaluation Tool (URET) http://ffp1.faa.gov/tools/tools_uret.asp (Accessed on October—2003)

(17) MITRE Corp.; “Free Flight Phase 1 Conflict Probe Operational Description”, March—2000.

(18) Federal Aviation Administration, Free Flight Phase 1—June 2001 Report http://ffp1.faa.gov/approach/media/pdfs/June2001_Report.pdf (Accessed on June—2003)

(19) Alvin McFarland and David Maroney; Eliminating the Altitude-for-Direction Rule and Implementing Reduced Vertical Minimum in the U.S., MITRE—Center for Advanced Aviation System Development, September—2001.

(20) http://www.mitrecaasd.org/proj/airspace_mgnt/idatoverview.cfm

### Heading

APPENDIX I—Intersection Model Overview

The Spreadsheet Computational Pseudo code

Identifying Route Conflicts:

```
            INTEGER VARIABLE Route ID1
// The First Route Identification // Number to be checked for conflict
            INTEGER VARIABLE Route ID2
// The Second Route to be checked // against the first one
```

| | |
|---|---|
| For Route ID1 = 1 to Max | // Max = Max number of Routes, which |
| { | // is = 6,464 in this case |
| For Route ID2 = 1 to Max | |
| { | |

```
    Get (Route ID1 and Route ID2) Info
    CHECK
    { IF (Route ID1 = Route ID2)
```

| | |
|---|---|
| THEN (CONFLICT ID = 0) } | // i.e. there is no INTERSECTION |

```
    CHECK
    { If (Origin (Route ID1) = Origin OR Destination (Route ID2)) IS TRUE
        OR
    If (Destination (Route ID1 = Origin OR Destination (Route ID2)) IS TRUE
```

| | |
|---|---|
| THEN (CONFLICT ID = 0) } | // i.e. there is no INTERSECTION |

```
    ELSE
    {
    FIND INTERSECTION POINTS (Great Circle Route ID1 and Great  Circle Route ID2)
    CHECK
```

| | |
|---|---|
| IF (any ONE of the INTERSECTION POINTS falls ON the | shortest |
| segment of the Great Circle of EITHER ROUTES) = TRUE | |
| THEN (CONFLICT ID = 1 AND, GET (INTERSECTION POINT | DATA)) |
| // Only Valid Intersection Point data for is collected. | // |
| Other non-Intersecting Points are set to some non- | // |
| significant number, 499 in this case | |
| } | |

| | |
|---|---|
| RETURN } | // Complete the Green “For Loop” |
| RETURN } | // Complete the Red “For Loop” |

### Heading

APPENDIX II—Data File Types & Associated Programs

*.xls (Microsoft Excel)

*.ppt (Microsoft PowerPoint)

*.mdb (Microsoft Access Database)

*.vsd (Microsoft Visio Flow Chart) also stored in a more universal *.vxd format

*.doc (Microsoft Word)

*.pdf (Adobe Acrobat Reader)

*.map (Manifold Geographic Information System) also stored in a more universal *.shp format

*.boot (FrameworkCT Professional or Above)

What is claimed is:

1. An innovative concept and methodology of using modified “Flexible (or Dynamic) Flight Level Assignment (FFLA) Rules” instead of in its current (static) format known as “Altitude-for-Direction (AFD)” rules and “Vertical Separation Minimum (VSM)” rules to proactively de-conflict the airspace, and its following associated suggested modifications. Instead of just segregating air-traffic in Eastward (bearing 0 to 179) and Westward (bearing 180 to 359), as done currently; and assigning alternative Flight Levels from altitude FL290 upwards as in current air-traffic setup, the suggested method would instead do the following: (a) It would optionally segregate the air-traffic in FLEXIBLE NUMBER of flight bearing based segmentations (like 1, 2, 4, 6, 8, etc . . . ) dependent on local air-traffic density in the given region of the airspace and then assign Altitude or Flight Level based on the local VSM in that region; and (b) It would optionally have flexible division boundaries (meaning, not necessarily equal angular separation of traffic segments) bearing based segmentations for each of the above flexible number of divisions; and (c) It would optionally “tweak” the FFLA Rule as in (a) and (b) in a particular region of the air-space to suite the given traffic density and characteristics of that air-space at a given time.

2. Encoding of the above claim 1. concept and methodology of manipulating AFD and VSM rule for the advantage of Air Traffic Management and Air-Space Capacity Enhancement into the following: (a) An algorithm that assigns the Flight Level for a particular air-route; (b) Associated computer program/s that includes the concepts, methodology, and algorithms mentioned in claim 1 and claim 2 (a); (c) Any hardware development carrying such computer programs and any specific implementation there of; (d) The Dataflow and Computational Architecture as shown in FIG. 18 of the Drawings Section of this document or similar schema of implementation, and associated implementation methodology and software development.

3. The Flight Path conflict identification Computational Algorithms including the following pieces: (a) The use of 3D Vector methodology as shown in Appendix I for route conflict identification; (b) The use the Excel or other similar File Program that encodes the algorithm in claim 4 (a) above into actual computational tool, and any software development that extends this algorithm implementation; (c) Subsequent Route Conflict Matrix (database) generation, including the Route Conflict data for major direct routes in the US Air Space; (d) Supporting data manipulation methodology that integrates that route conflict data with air-traffic scheduling to compute “conflict probability” using software implementation in claim 3; and (e) The further use of conflict matrix and probability data to Optimize Flexible Flight Level Assignment (Air Traffic) Rules based on regional air-traffic characteristic and associated methodology, algorithm and software implementation of such intention.

4. The use of GPS based precision “certified flight path routing” in combination with the Flexible Flight Level Assignment as suggested in claims above, and Flight Compliance Tracking System for the purpose of “Homeland Security Surveillance”, and associated methodology, algorithms, and implementation software & applications. The important result of this change will be to transform the current system, based on airspace, to one of certified flight paths. Aircraft will now be identified as not in compliance once they deviate from their certified flight paths. The net effect of which is to increase the amount of time to determine the nature of the deviation of the aircraft well before it can enter any sensitive airspace.
